(19) United States
(12) Patent Application Publication
(10) Pub. No.: US 2024/0086846 A1
(43) Pub. Date: Mar. 14, 2024

(54) OPERATION MANAGEMENT SYSTEM AND OPERATION MANAGEMENT METHOD

(71) Applicant: Hitachi, Ltd., Tokyo (JP)

(72) Inventors: Hiroki YAMAMOTO, Tokyo (JP); Koji AMANO, Tokyo (JP); Kazuma SAWADA, Tokyo (JP); Hiroshi YAMADA, Tokyo (JP); Yudai ZAMA, Tokyo (JP)

(73) Assignee: Hitachi, Ltd., Tokyo (JP)

(21) Appl. No.: 18/273,167

(22) PCT Filed: Aug. 30, 2021
(86) PCT No.: PCT/JP2021/031662

§ 371 Date: Jul. 19, 2023

(30) Foreign Application Priority Data
Feb. 19, 2021 (JP) 2021-025275

(51) Int. Cl. G06Q 10/10

(52) U.S. Cl. CPC G06Q 10/103

(57) ABSTRACT

An operation management system manages operations carried out by people in charge of operation regarding a common operation target, including: an operation information database storing operation information related to implementation of the operations; a start notification unit that notifies each person of the start of each operation when the start notification unit detects occurrence of a predetermined trigger event in the operation target; an operation flow construction unit that constructs an operation flow indicating the operation to be carried out by each person in relation to the trigger event, on the basis of the operation information database; an information providing unit that provides, to each person, the operation information with content suitable for the person in charge of operation on the basis of the operation flow; and a progress notification unit that notifies each person of progress of the operation.

### TECHNICAL FIELD

The present invention relates to a system and a method of managing operations carried out by a plurality of persons in charge of operation in relation to a common operation target.

### BACKGROUND ART

A technique described in, for example, Patent Document 1 is known in relation to the present invention. A production book server is disclosed in Patent Document 1, in which, for example, in a system that stores, in a core system, various types of information related to operations and that comprehensively manages the operation information of each department at the head office, the production book server presents, to a viewer, only information stored in the core system necessary for the viewer, in a format that the viewer can easily view the information, regardless of the section the viewer belongs to. In the production book server, items of information that each viewer wants to view and presentation formats for presenting the information are registered as presentation pattern information of each viewer, and information corresponding to an information search request from the viewer is presented to a terminal of the viewer on the basis of the presentation pattern information.

### PRIOR ART DOCUMENT

### Patent Document

Patent Document 1: JP-2003-36275-A

### SUMMARY OF THE INVENTION

### Problem to be Solved by the Invention

In the production book server described in Patent Document 1, the information is presented according to the information search request from the viewer, and therefore, information useful for carrying out the operation may not be presented at optimal timing. In addition, when a plurality of persons in charge of operation carry out operations in relation to a common operation target, such as handling an abnormality of a device, the persons in charge of operation need to perform the operations in cooperation with each other. However, the cooperation of operations among the persons in charge of operation is not taken into account in the production book server described in Patent Document 1, and it is difficult to present appropriate information.

In view of the problem of the conventional technique, an object of the present invention is to appropriately manage operations carried out by a plurality of persons in charge of operation in relation to a common operation target and to provide push information necessary for executing the operations.

### Means for Solving the Problem

The present invention provides an operation management system that manages operations carried out by a plurality of persons in charge of operation in relation to a common operation target, the operation management system including: an operation information database that stores operation information related to implementation of the operations; a start notification unit that notifies each person in charge of operation of start of each of the operations when the start notification unit detects occurrence of a predetermined trigger event in the operation target; an operation flow construction unit that constructs an operation flow indicating the operation to be carried out by each person in charge of operation in relation to the trigger event, on the basis of the operation information database; an information providing unit that provides, to each person in charge of operation, the operation information with content suitable for the person in charge of operation on the basis of the operation flow; and a progress notification unit that notifies each person in charge of operation of progress of the operation.

The present invention provides an operation management method of, by using a computer, managing operations carried out by a plurality of persons in charge of operation in relation to a common operation target, the operation management method including: connecting an operation information database that stores operation information related to implementation of the operations to the computer; and by the computer, notifying each person in charge of operation of start of each of the operations when detecting occurrence of a predetermined trigger event in the operation target; constructing an operation flow indicating the operation to be carried out by each person in charge of operation in relation to the trigger event, on the basis of the operation information database that stores the operation information related to the implementation of the operations; providing, to each person in charge of operation, the operation information with content suitable for the person in charge of operation on the basis of the operation flow; and notifying each person in charge of operation of progress of the operation.

### Advantages of the Invention

According to the present invention, the operations carried out by a plurality of persons in charge of operation in relation to a common operation target can be appropriately managed.

### BRIEF DESCRIPTION OF THE DRAWINGS

FIG. 1 is a diagram illustrating an overview of the present invention.

FIG. 2 is a configuration diagram of an operation management system according to an embodiment of the present invention.

FIG. 3 is a diagram illustrating an overview of an action of the operation management system according to an embodiment of the present invention.

FIG. 4 is a diagram illustrating an example of structured data based on sensor information.

FIG. 5 is a diagram illustrating an example of the structured data based on the sensor information when a trigger event occurs.

FIG. 6 is a diagram illustrating a functional configuration of an information providing unit.

FIG. 7 is a diagram illustrating an example of operation information provided by the information providing unit.

FIG. 8 is a diagram illustrating an example of screens displaying the operation information in terminal apparatuses.

FIG. 9 is a flow chart illustrating a flow of a process of the operation management system according to an embodiment of the present invention.

FIG. 10 is a diagram illustrating a flow of an operation when the operation management system according to an embodiment of the present invention is used.

### MODES FOR CARRYING OUT THE INVENTION

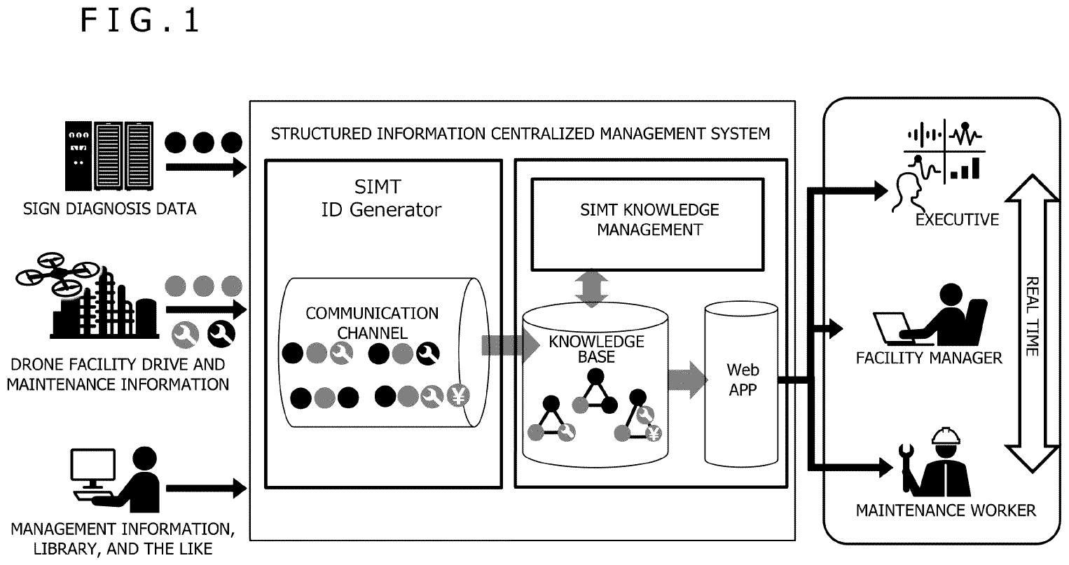

FIG. 1 is a diagram illustrating an overview of the present invention. A structured information centralized management system illustrated in FIG. 1 is a system that uses a method called structured information centralized management technology (SIMT: Structured Identifier Management Technology) to form a database of various types of information related to a target facility, such as a chemical plant installed in a factory, and that comprehensively manages the database as a knowledge base to thereby support the maintenance operation of the target facility.

In FIG. 1, the structured information centralized management system collects various types of information, such as sign diagnosis data output from a sign diagnosis system that diagnoses the sign of an abnormality in the target facility, maintenance information obtained by using a drone or other observation devices to observe the target facility, and management information related to the management of the target facility. The structured information centralized management system then provides a unique ID called a structured ID to each piece of the collected information to thereby convert the information into structured data that allows to individually identify the information. The structured information centralized management system further combines the structured data with relationship links indicating the relationships between the structured IDs provided to the structured data, and stores the combinations in the knowledge base. The structured information centralized management system provides the information stored in the knowledge base in this way to the users, such as an executive, a facility manager, and a maintenance worker, through a Web app, and necessary information can be shared by the users in real time.

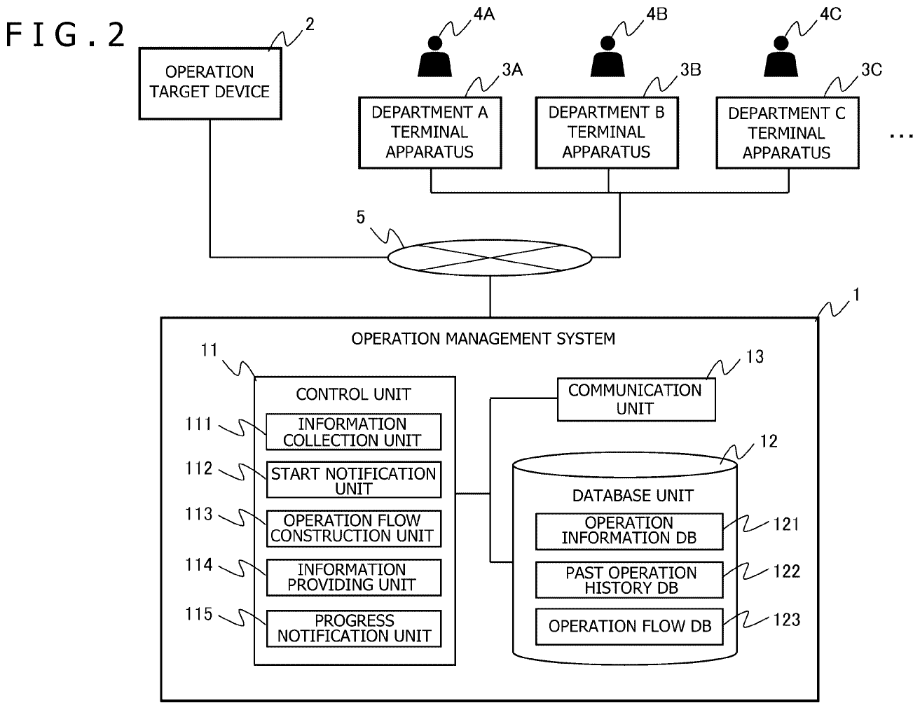

FIG. 2 is a configuration diagram of an operation management system according to an embodiment of the present invention. An operation management system 1 illustrated in FIG. 2 corresponds to an embodiment of the present invention in which the structured information centralized management system described in FIG. 1 is applied.

In FIG. 2, the operation management system 1 is connected to an operation target device 2 and terminal apparatuses 3A, 3B, and 3C through a network 5, and the operation management system 1 manages operations carried out by persons 4A, 4B, and 4C in charge of operation in relation to the common operation target device 2. The network 5 includes, for example, a LAN or the Internet, and the network 5 relays information transmitted and received between the operation management system 1 and the operation target device 2 and between the operation management system 1 and the terminal apparatuses 3A, 3B, and 3C. Note that although FIG. 2 illustrates an example in which three terminal apparatuses 3A, 3B, and 3C connected to the operation management system 1 are operated by the person 4A in charge of operation belonging to a department A, the person 4B in charge of operation belonging to a department B, and the person 4C in charge of operation belonging to a department C, respectively, the number of terminal apparatuses and persons in charge of operation is not limited to this.

The operation management system 1 monitors the operation target device 2, detects an abnormality if there is an abnormality in the operation target device 2, and notifies the persons 4A, 4B, and 4C in charge of operation of the abnormality through the terminal apparatuses 3A, 3B, and 3C. The operation management system 1 then issues an operation instruction for handling the notified abnormality to each of the persons 4A, 4B, and 4C in charge of operation. The operation management system 1 in this case acquires various types of operation information useful for carrying out the operation (for example, a design drawing or a procedure manual used to handle a similar instance in the past) for each department that each person in charge of operation belongs to and provides the operation information to the persons 4A, 4B, and 4C in charge of operation through the terminal apparatuses 3A, 3B, and 3C, respectively. In this way, the operation management system 1 supports the operation carried out by each person in charge of operation in relation to the operation target device 2. Note that the details of the operation management system 1 will be described later.

The operation target device 2 is a target device of the operations performed by the persons 4A, 4B, and 4C in charge of operation, and the operation target device 2 is monitored by the operation management system 1. The operation target device 2 can be, for example, a chemical plant installed in a factory. Note that the operation target device 2 may be a single device or may be a system including a combination of a plurality of devices and computers. Both cases are included in the following description.

The terminal apparatuses 3A, 3B, and 3C are information devices that present, to the persons 4A, 4B, and 4C in charge of operation of the departments, respectively, the operation information provided from the operation management system 1, and examples of the terminal apparatuses 3A, 3B, and 3C include personal computers, smartphones, and tablet terminals. The terminal apparatus 3A is installed at a predetermined position in a work space of the department A, or the person 4A in charge of operation belonging to the department A holds the terminal apparatus 3A. The terminal apparatus 3A functions as a user interface for providing the operation information from the operation management system 1 to the person 4A in charge of operation. Similarly, the terminal apparatus 3B is installed at a predetermined position in a work space of the department B, or the person 4B in charge of operation belonging to the department B holds the terminal apparatus 3B. The terminal apparatus 3B functions as a user interface for providing the operation information from the operation management system 1 to the person 4B in charge of operation. In addition, the terminal apparatus 3C is installed at a predetermined position in a work space of the department C, or the person 4C in charge of operation belonging to the department C holds the terminal apparatus 3C. The terminal apparatus 3C functions as a user interface for providing the operation information from the operation management system 1 to the person 4C in charge of operation.

The operation management system 1 includes a control unit 11, a database unit 12, and a communication unit 13 that are connected to each other.

The control unit 11 has functions including an information collection unit 111, a start notification unit 112, an operation flow construction unit 113, an information providing unit 114, and a progress notification unit 115. The control unit 11 includes, for example, a CPU, a ROM, and a RAM, and the control unit 11 can execute predetermined programs to realize the functions of the information collection unit 111, the start notification unit 112, the operation flow construction unit 113, the information providing unit 114, and the progress notification unit 115. Note that hardware, such as an FPGA (Field-Programmable Gate Array), may be used to realize part or all of the functions included in the control unit 11.

The information collection unit 111 collects various types of information related to the state of the operation target device 2. The information collected by the information collection unit 111 includes, for example, sensor information acquired by various sensors installed for a plurality of components included in the operation target device 2. The information collection unit 111 can collect, from the operation target device 2, the sensor information obtained by measuring physical quantities, such as temperature, humidity, pressure, vibration, current, voltage, and strain of the components. The information collected by the information collection unit 111 is converted into structured data by being provided with the structured ID, and the structured data is input to the start notification unit 112. Note that the structured data generated based on the information collected by the information collection unit 111 may be stored in the database unit 12 to construct the knowledge base.

The start notification unit 112 determines the driving state of the operation target device 2 on the basis of the information collected by the information collection unit 111. In addition, when an event (trigger event) occurs in the operation target device 2 for which event the persons in charge of operation need to carry out the operations, the start notification unit 112 detects the trigger event and notifies the persons in charge of operation of the trigger event. Note that the trigger event detected by the start notification unit 112 corresponds to an abnormality or the sign of abnormality occurred in the operation target device 2, and an example of the trigger event includes an abnormal value of the sensor information. In addition, the start notification unit 112 can also handle a trigger event raised by the person in charge of operation, such as start of management maintenance work.

Once the start notification unit 112 notifies the persons in charge of operation of the trigger event, the operation flow construction unit 113 constructs an operation flow for indicating the operations that need to be carried out by the persons in charge of operation in relation to the occurred trigger event. The operation flow represents a flow of operations of the persons in charge of operation necessary for recovering the operation target device 2 from the abnormal state, and the content of the constructed operation flow varies according to the type of trigger event.

The information providing unit 114 searches and acquires, from the database unit 12, the operation information useful for each person in charge of operation to carry out the operation on the basis of the operation flow constructed by the operation flow construction unit 113, and provides the operation information to each person in charge of operation. The operation information acquired by the information providing unit 114 from the database unit 12 is transmitted from the information providing unit 114 to the terminal apparatuses 3A, 3B, and 3C, and is provided to the persons 4A, 4B, and 4C in charge of operation through the terminal apparatuses 3A, 3B, and 3C. In this case, the information providing unit 114 separately transmits the acquired operation information to each terminal apparatus in order to provide the operation information suitable for the department that each of the persons 4A, 4B, and 4C in charge of operation belongs to. As a result, the operation information with optimal content that varies according to the department each person in charge of operation belongs to is provided from the information providing unit 114 to each person in charge of operation.

The progress notification unit 115 notifies each person in charge of operation of the progress of the operation performed by the person in charge of operation. For example, the progress notification unit 115 notifies each person in charge of operation of the percentage of the operation already carried out by each person in charge of operation with respect to the entire operation in the operation flow constructed by the operation flow construction unit 113. The notification is transmitted from the information providing unit 114 to the terminal apparatuses 3A, 3B, and 3C and transferred to the persons 4A, 4B, and 4C in charge of operation through the terminal apparatuses 3A, 3B, and 3C.

The database unit 12 includes a non-volatile recording medium, such as an HDD (Hard Disk Drive) and an SSD (Solid State Drive). Databases including an operation information database 121, a past operation history database 122, and an operation flow database 123 (hereinafter, the database may be abbreviated as “DB”) are recorded in the database unit 12.

The operation information DB 121 is a database storing operation information including design drawings, procedure manuals, and the like of the components of the operation target device 2. Various types of operation information regarding the department A, the department B, and the department C are stored in the operation information DB 121 in association with the departments. The operation information stored in the operation information DB 121 is read by the information providing unit 114, transmitted to the terminal apparatuses 3A, 3B, and 3C, and provided to the persons 4A, 4B, and 4C in charge of operation.

The past operation history DB 122 is a database storing history information of the operations performed in the past in relation to the operation target device 2. Information, such as types, date, and time of trigger events occurred in the past, content of operation information provided from the operation management system 1 to each person in charge of operation, details of operation carried out by each person in charge of operation, and details of abnormality specified in the operation, is recorded as history information of past operations in the past operation history DB 122.

The operation flow DB 123 is a database storing past operation flows corresponding to the trigger events occurred in the past in the operation target device 2. The operation flow construction unit 113 can use the past operation flows stored in the operation flow DB 123 to construct the operation flow in relation to the trigger event of this time.

The communication unit 13 manages the communication between the control target device 2 and the operation management system 1 and between the network 5 and the operation management system 1.

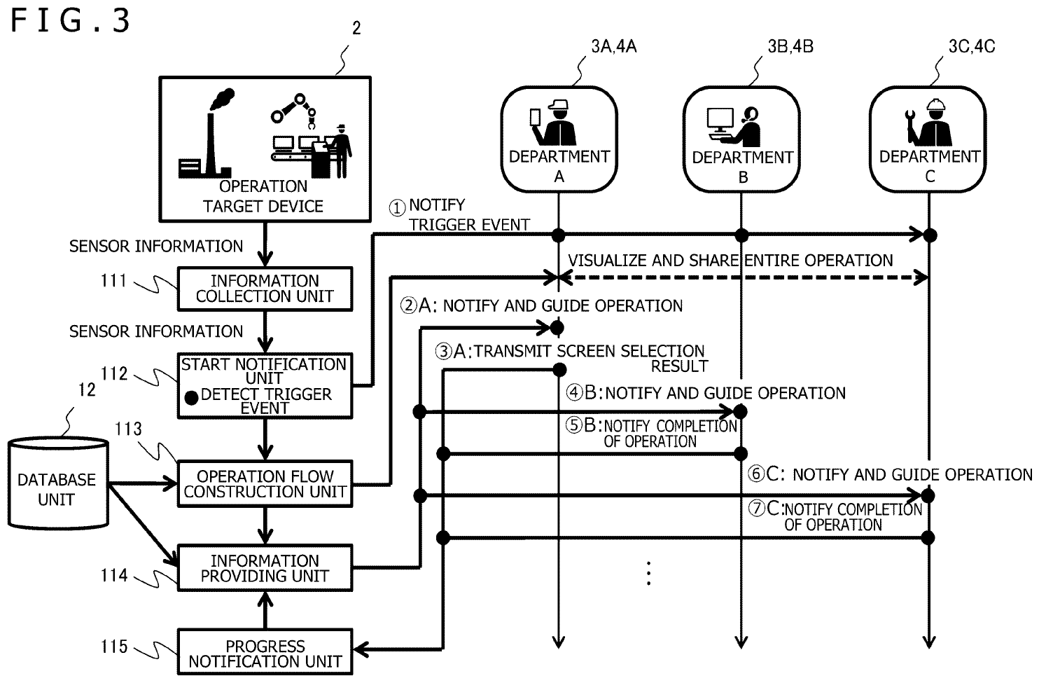

FIG. 3 is a diagram illustrating an overview of an action of the operation management system according to an embodiment of the present invention. The operation management system 1 illustrated in FIG. 2 performs, for example, the action described below to support each person in charge of operation to carry out the operation in relation to the operation target device 2.

Various types of sensor information output from the sensors installed on the operation target device 2 are collected by the information collection unit 111 and input to the start notification unit 112. When there is an abnormality or the sign of abnormality in the operation target device 2, the start notification unit 112 detects the abnormality or the sign of abnormality on the basis of the input sensor information and notifies each of the department A, the department B, and the department C of the trigger event. The terminal apparatuses 3A, 3B, and 3C display predetermined screens or output sound to notify the persons 4A, 4B, and 4C in charge of operation of the trigger event.

Once the start notification unit 112 notifies the persons 4A, 4B, and 4C in charge of operation of the trigger event, the operation flow construction unit 113 uses the operation flow DB 123 stored in the database unit 12 to construct the operation flow and inputs the operation flow to the information providing unit 114. In addition, the operation flow construction unit 113 transmits the constructed operation flow to the terminal apparatuses 3A, 3B, and 3C and causes the terminal apparatuses 3A, 3B, and 3C to display the constructed operation flow to thereby allow the persons 4A, 4B, and 4C in charge of operation to visualize and share the entire operation. As a result, each of the persons 4A, 4B, and 4C in charge of operation can figure out the details of the operation that needs to be carried out by the person in charge of operation, and can figure out the details of the operations to be carried out by the other persons in charge of operation as necessary.

The information providing unit 114 searches for necessary operation information from the operation information DB 121 stored in the database unit 12 on the basis of the input operation flow, and provides the operation information to the department A, the department B, and the department C. For example, the information providing unit 114 provides the operation information to the terminal apparatus 3A of the department A according to the order of carrying out the operations indicated in the operation flow to thereby notify the person 4A in charge of operation of the operation and guide the person 4A in charge of operation for the operation.

Once the person 4A in charge of operation receives the operation notification from the information providing unit 114, the person 4A in charge of operation carries out the operation in relation to the operation target device 2 corresponding to the occurred trigger event. In addition, the person 4A in charge of operation operates the terminal apparatus 3A after the end of the operation, and selects a predetermined screen on the screen displayed on the terminal apparatus 3A. The screen selection result is transmitted from the terminal apparatus 3A to the operation management system 1, and the operation management system 1 inputs the screen selection result to the progress notification unit 115.

Once the screen selection result transmitted from the terminal apparatus 3A is input, the progress notification unit 115 reflects the end of the operation of the person 4A in charge of operation on the operation flow displayed on the terminal apparatuses 3A, 3B, and 3C. In addition, the progress notification unit 115 notifies the information providing unit 114 of the end of the operation of the person 4A in charge of operation. In response to the notification, the information providing unit 114 provides the operation information to the terminal apparatus 3B of the department B according to the order of carrying out the operation indicated in the operation flow to thereby notify the person 4B in charge of operation of the operation and guide the person 4B in charge of operation for the operation.

Once the person 4B in charge of operation receives the operation notification from the information providing unit 114, the person 4B in charge of operation carries out the operation in relation to the operation target device 2 corresponding to the occurred trigger event. In addition, the person 4B in charge of operation operates the terminal apparatus 3B after the end of the operation, and selects a predetermined screen on the screen displayed on the terminal apparatus 3B. The screen selection result is transmitted from the terminal apparatus 3B to the operation management system 1, and the operation management system 1 inputs the screen selection result to the progress notification unit 115.

Once the screen selection result transmitted from the terminal apparatus 3B is input, the progress notification unit 115 reflects the end of the operation of the person 4B in charge of operation on the operation flow displayed on the terminal apparatuses 3A, 3B, and 3C. In addition, the progress notification unit 115 notifies the information providing unit 114 of the end of the operation of the person 4B in charge of operation. In response to the notification, the information providing unit 114 provides the operation information to the terminal apparatus 3C of the department C according to the order of carrying out the operation indicated in the operation flow to thereby notify the person 4C in charge of operation of the operation and guide the person 4C in charge of operation for the operation.

Once the person 4C in charge of operation receives the operation notification from the information providing unit 114, the person 4C in charge of operation carries out the operation in relation to the operation target device 2 corresponding to the occurred trigger event. In addition, the person 4C in charge of operation operates the terminal apparatus 3C after the end of the operation and selects a predetermined screen on the screen displayed on the terminal apparatus 3C. The screen selection result is transmitted from the terminal apparatus 3C to the operation management system 1, and the operation management system 1 inputs the screen selection result to the progress notification unit 115.

The operation management system 1 repeatedly notifies the persons in charge of operation of the operations as described above according to the operation flow constructed by the operation flow construction unit 113. When all of the operations indicated in the operation flow are finished, the operation management system 1 notifies the persons in charge of operation of the end of the operations and ends the action.

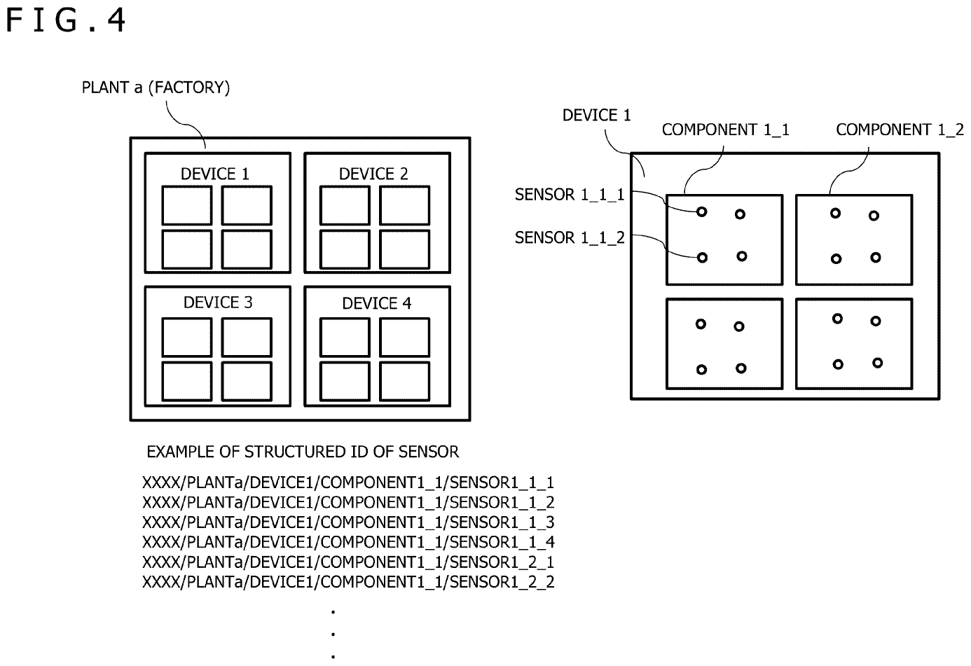

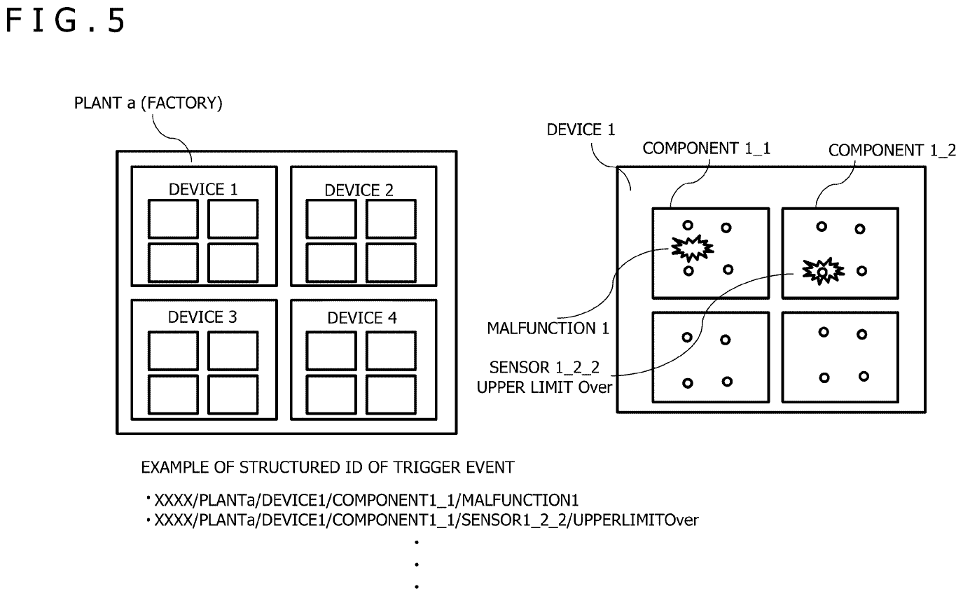

FIGS. 4 and 5 are diagrams illustrating examples of the structured data based on the sensor information. FIG. 4 illustrates a state in which a factory (plant a) that is the operation target device 2 includes four devices, and a plurality of sensors are attached to the components included in each device. In this case, a structured ID including a combination of IDs of the sensor, the component, the device, and the plant is provided to each piece of the sensor information acquired by each sensor to thereby generate structured data based on the sensor information as illustrated in FIG. 4. The structured data generated in this way is output from the information collection unit 111 to the start notification unit 112 as described above, and the structured data is used to raise a trigger event or to construct an operation flow. The database unit 12 also uses the structured data to construct a knowledge base.

FIG. 5 illustrates an example of the structured data based on the sensor information when a trigger event occurs. When a malfunction or an abnormality occurs in the plant a, and any one of the sensors detects the sensor information corresponding to the malfunction or the abnormality, the information of the malfunction or the abnormality is also recorded in the structured data.

In the example illustrated in FIG. 5, an abnormality warning of an upper limit Over of a sensor 1_2_2 can be shared by the departments as illustrated in the example of the structured ID of the trigger event. In addition, the configuration of the entire device or components can be taken into account to calculate and share the level or the rate of the failure. For example, when four sensors are provided on a component 1_2 in the case of the example illustrated in FIG. 5, “failure rate of component 1_2: 25%” can be displayed. Similarly, when 16 sensors are provided on the device 1, “failure rate of device 1: 6%” can be displayed. In addition, this can be chronologically displayed to display a graph of the time course of the progress of the failure.

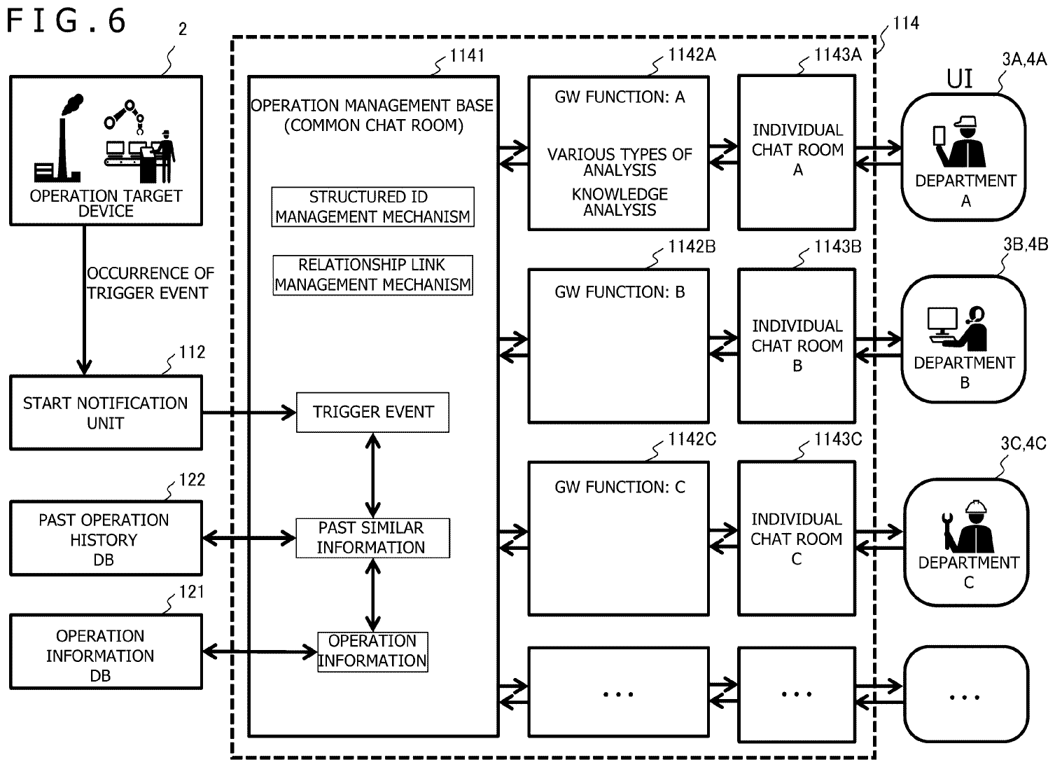

FIG. 6 is a diagram illustrating a functional configuration of the information providing unit 114. As illustrated in FIG. 6, the information providing unit 114 has functions including an operation management base 1141, gate (GW) functions 1142, and individual chat rooms 1143. Note that the gateway function 1142 and the individual chat room 1143 are set for each person in charge of operation. FIG. 6 illustrates a state in which gateway functions 1142A, 1142B, and 1142C and individual chat rooms 1143A, 1143B, and 1143C are set for the department A, the department B, and the department C, respectively.

The operation management base 1141 includes a structured ID management mechanism and a relationship link management mechanism. The structured ID management mechanism is used to convert the information collected by the information collection unit 111 from the sensors into the structured data. The relationship link management mechanism is used to construct the knowledge base from the structured data. In addition, the operation management base 1141 searches the past operation history DB 122 and the operation information DB 121 to acquire past similar information and operation information in response to the notification of the trigger event from the start notification unit 112.

The gateway function 1142 has a relay function of information input and output between the operation management base 1141 and the individual chat rooms 1143. In addition, the gateway function 1142 can use the structured data generated by the operation management base 1141 to perform various types of analysis and knowledge analysis.

The individual chat rooms 1143 provide, to the terminal apparatuses 3A, 3B, and 3C installed in the departments, user interfaces for the persons 4A, 4B, and 4C in charge of operation, respectively. The persons in charge of operation can operate the terminal apparatuses 3A, 3B, and 3C to receive necessary operation information from the information providing unit 114 through the individual chat rooms 1143.

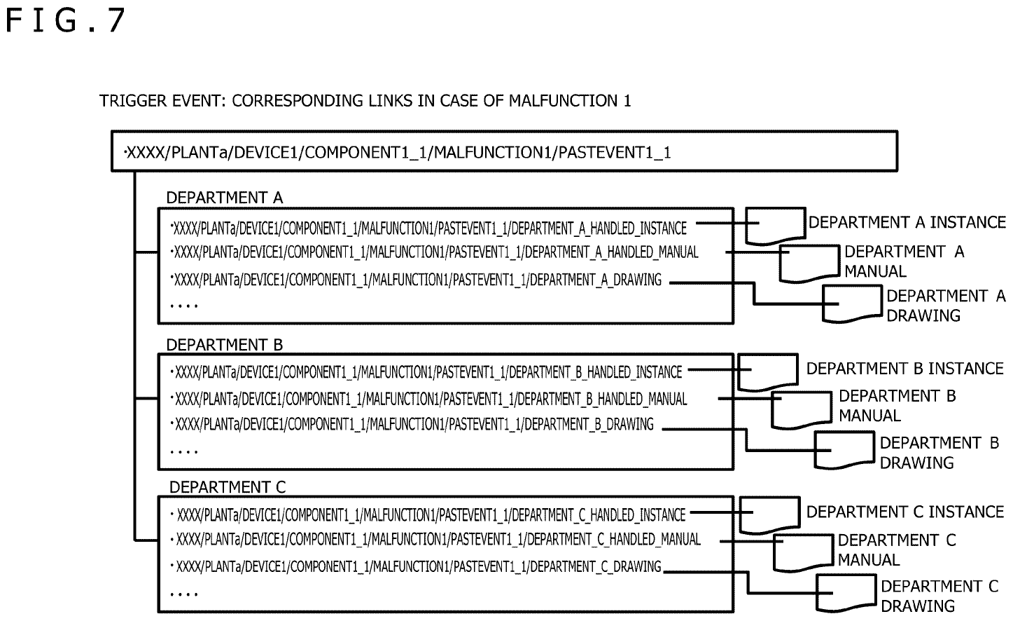

FIG. 7 is a diagram illustrating an example of the operation information provided by the information providing unit 114. FIG. 7 illustrates an example of a case in which, for example, a malfunction 1 as a trigger event occurs in a component 1_1 included in the device 1 of the plant a. In this case, the information providing unit 114 provides the operation information of instances, manuals, and drawings used in the department A, the department B, and the department C in a past event 1_1 for the malfunction 1 to the persons 4A, 4B, and 4C in charge of operation through the terminal apparatuses 3A, 3B, and 3C, respectively. The operation information is managed by the operation management system 1 as structured data provided with the structured ID of the past event 1_1 for the malfunction 1, as with the structured data based on the sensor information described in FIGS. 4 and 5.

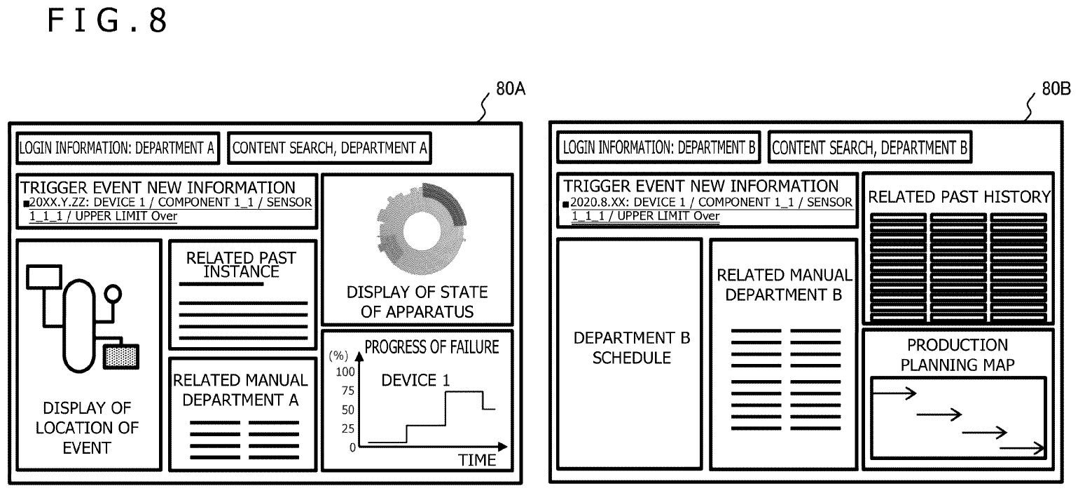

FIG. 8 is a diagram illustrating an example of the screens displaying the operation information in the terminal apparatuses 3A and 3B. The information providing unit 114 displays, for example, a screen 80A in the terminal apparatus 3A to provide the operation information to the person 4A in charge of operation. The screen 80A indicates the location of the occurrence of the malfunction (trigger event) in the plant a that is the operation target device 2, a past instance related to the malfunction, a manual for the department A, the state of apparatus, a trend display of the progress of the failure in the device 1, and the like. In addition, the information providing unit 114 displays, for example, a screen 80B in the terminal apparatus 3B to provide the operation information to the person 4B in charge of operation. The screen 80B indicates a schedule for the department B in relation to the malfunction, a manual, a related past history, a production planning map, and the like.

As illustrated in the trend display of the progress of the failure on the screen 80A, the trend of various types of data can be displayed. For example, the value of a sensor of interest, the credibility of the abnormality compared to past instances, the seriousness of malfunction, and the like can be displayed in cooperation with the operation system.

Note that the content of the screens 80A and 80B is just an example, and operation information suitable for each department can be provided on an optional screen display according to the difference in the details of the trigger event or the operation range of each department.

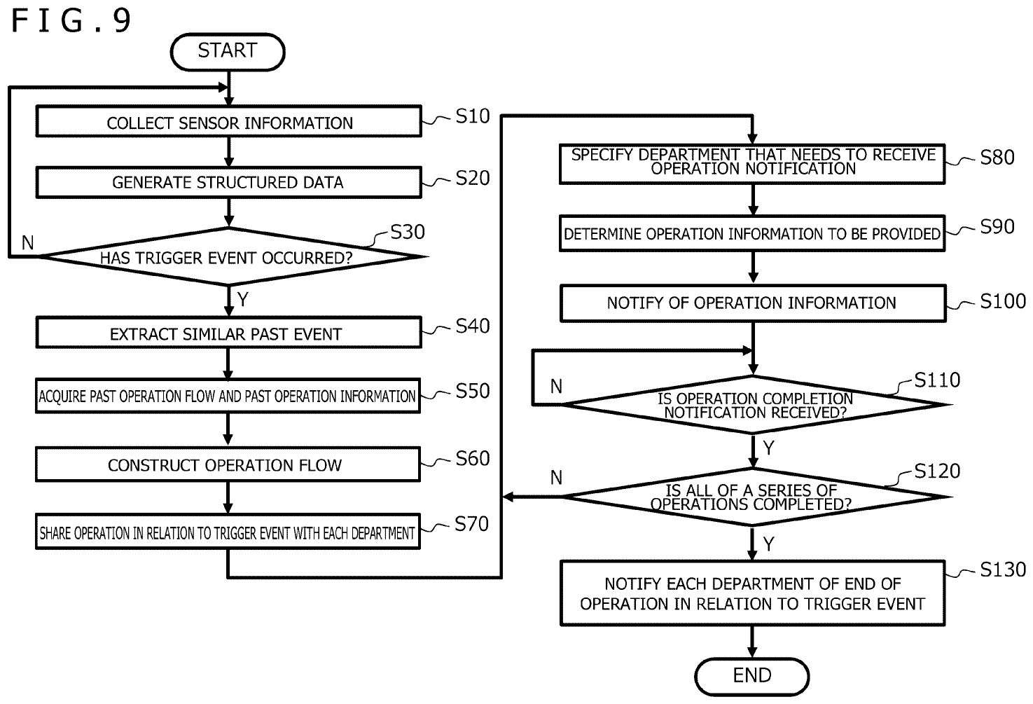

FIG. 9 is a flow chart illustrating a flow of the process of the operation management system according to an embodiment of the present invention. In the operation management system 1, the CPU executes a predetermined program in the control unit 11 to execute the process illustrated in the flow chart of FIG. 9, for example.

In step S10, the information collection unit 111 collects the sensor information from the sensors attached to the components of the operation target device 2.

In step S20, the information collection unit 111 provides the structured IDs to the sensor information collected in step S10 to generate structured data.

In step S30, the start notification unit 112 determines whether a trigger event has occurred in the operation target device 2 on the basis of the structured data generated in step S20. If the structured data satisfies a predetermined trigger event occurrence condition, such as when the value of the sensor information in the structured data exceeds a predetermined normal range, the start notification unit 112 determines that the trigger event has occurred. The start notification unit 112 detects the trigger event and proceeds to step S40. On the other hand, if the structured data does not satisfy the trigger event occurrence condition, the start notification unit 112 determines that the trigger event has not occurred and returns to step S10.

In step S40, the start notification unit 112 extracts a past event similar to the trigger event detected in step S30 from the past operation history DB 122 of the database unit 12. In step S50, the start notification unit 112 acquires a past operation flow and operation information corresponding to the similar past event extracted in step S40 from the operation flow DB 123 and the operation information DB 121 of the database unit 12, respectively.

In step S60, the operation flow construction unit 113 constructs an operation flow for handling the trigger event detected in step S30, on the basis of the past operation flow acquired in step S50. Here, the operation flow construction unit 113 may use the acquired past operation flow as it is to construct the operation flow or may change part of the acquired past operation flow on the basis of the details of the trigger event to construct the operation flow. For example, when the operation range of each department indicated in the past operation flow and the current operation range of each department are different from each other, the correspondence between the operation ranges can be set in advance in the operation flow construction unit 113 to appropriately modify the past operation flow according to the trigger event. Therefore, an operation flow suitable for the current organization structure can be constructed.

In step S70, the operation flow construction unit 113 shares the operation flow constructed in step S60 with each department. Here, the operation flow construction unit 113 transmits the constructed operation flow to the terminal apparatuses 3A, 3B, and 3C and causes the terminal apparatuses 3A, 3B, and 3C to display the constructed operation flow to allow the persons 4A, 4B, and 4C in charge of operation belonging to the department A, the department B, and the department C, respectively, to visualize and share the whole image of the series of operations executed to handle the trigger event.

In step S80, the information providing unit 114 specifies, as a department that needs to receive an operation notification, the department that needs to carry out the operation next in relation to the operation target device 2. Here, the information providing unit 114 specifies any one of the department A, the department B, and the department C as the target department of the next operation notification according to the order of carrying out the operations of the departments in the operation flow constructed in step S60.

In step S90, the information providing unit 114 determines the operation information to be provided to the target department of the operation notification specified in step S80. Here, the information providing unit 114 determines the operation information to be provided to the department on the basis of the past operation information acquired in step S50. Note that as described above, various types of operation information regarding each of the department A, the department B, and the department C are stored in the operation information DB 121 in association with each department. Therefore, it is preferable that the information providing unit 114 in step S90 extract the operation information to be provided from the past operation information so that the operation information corresponding to the department is provided to the person in charge of operation belonging to the target department of the operation notification among the persons 4A, 4B, and 4C in charge of operation, in priority to the operation information of the other departments. In addition, priorities may be set for the plurality of pieces of operation information stored in the operation information DB 121, and the information providing unit 114 may determine the operation information to be provided to the department on the basis of the priorities. Alternatively, the persons 4A, 4B, and 4C in charge of operation may operate the terminal apparatuses 3A, 3B, and 3C to optionally select the operation information to be provided from the information providing unit 114. In addition to these, optional methods may be used to determine the operation information to be provided to the target device of the operation notification.

In step S100, the information providing unit 114 notifies the department of the operation information determined in step S90. Here, the information providing unit 114 transmits the operation information determined in step S90 to any one of the terminal apparatuses 3A, 3B, and 3C installed in the target department of the operation notification specified in step S80 among the department A, the department B, and the department C and causes the terminal apparatus to display the operation information. As a result, any one of the screens 80A and 80B of FIG. 8 is displayed on any one of the terminal apparatuses 3A and 3B, for example. As a result, the operation information useful for carrying out the operation can be provided to the person in charge of operation who needs to carry out the operation next among the persons 4A, 4B, and 4C in charge of operation.

In step S110, the operation management system 1 determines whether an operation completion notification is received from the person in charge of operation in relation to the operation information notified in step S100. The person in charge of operation belonging to the target department of the operation notification specified in step S80 among the persons 4A, 4B, and 4C in charge of operation uses any one of the terminal apparatuses 3A, 3B, and 3C to perform a predetermined operation to input a notification of the completion of the operation when the operation instructed in the operation notification is completed. The notification is transmitted from the terminal apparatus to the operation management system 1 through the network 5. The operation management system 1 stays in step S110 until the operation management system 1 receives the operation completion notification from the terminal apparatus that has transmitted the operation information in step S100, and the operation management system 1 proceeds to step S120 once the operation management system 1 receives the operation completion notification.

In step S120, the operation management system 1 determines whether all of the series of operations illustrated in the operation flow constructed in step S60 is completed. If an operation not carried out in the operation flow still remains, the operation management system 1 returns to step S80 and repeats the process as described above for the operation that is not carried out. If there is no operation not carried out in the operation flow, and all of the series of operations is completed, the operation management system 1 proceeds to step S130.

In step S130, the operation management system 1 notifies each department of the end of all operations in relation to the trigger event detected in step S30. Here, for example, the operation management system 1 indicates a predetermined display expressing the completion of the series of operations of the operation flow in the operation flow displayed on each of the terminal apparatuses 3A, 3B, and 3C in step S70 to thereby share, with the persons 4A, 4B, and 4C in charge of operation belonging to the department A, the department B, and the department C, respectively, the fact that the handling of the trigger event is completed.

Once the process of step S130 is finished, the operation management system 1 ends the process illustrated in the flow chart of FIG. 9.

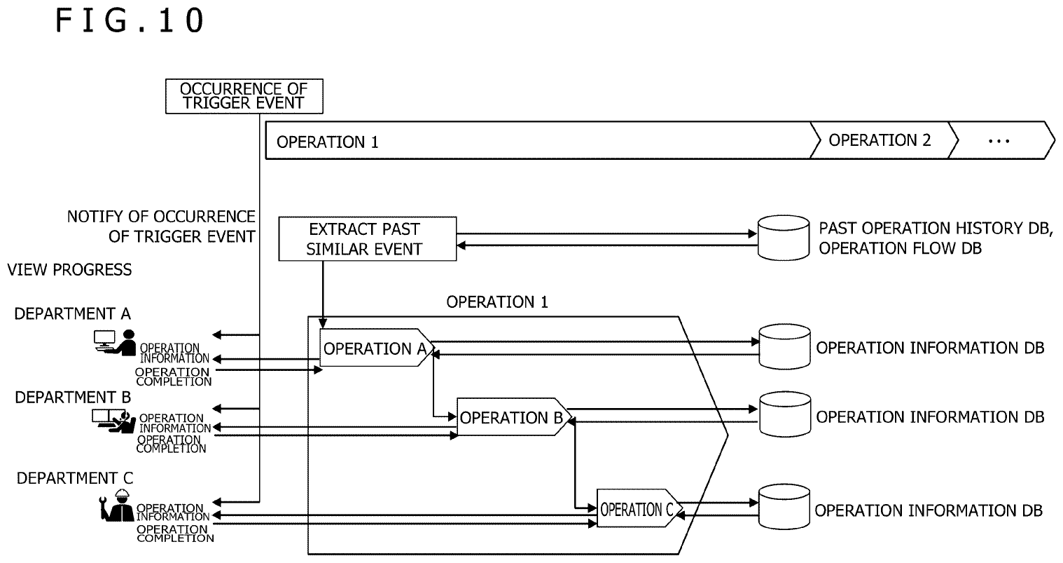

FIG. 10 is a diagram illustrating a flow of the operation when the operation management system according to an embodiment of the present invention is used.

When a trigger event occurs in the operation target 2, the operation management system 1 notifies the terminal apparatuses 3A, 3B, and 3C installed in the department A, the department B, and the department C, respectively, of the occurrence of the trigger event. In addition, the operation management system 1 refers to the past operation history DB 122 and the operation flow DB 123 to extract a past similar event and constructs an operation flow in relation to the trigger event. For each operation indicated in the operation flow, the operation management system 1 extracts the operation information from the operation information DB 121 for each department and transmits the operation information to the terminal apparatuses 3A, 3B, and 3C to thereby provide the operation information necessary for the operation to each of the persons 4A, 4B, and 4C in charge of operation.

Once the persons 4A, 4B, and 4C in charge of operation that have received the operation information from the operation target device 2 complete the operations of the persons in charge of operation, the persons 4A, 4B, and 4C in charge of operation operate the terminal apparatuses 3A, 3B, and 3C, respectively, to notify the operation target device 2 of the completion of the operations. Once the operation target device 2 receives the notification of the completion of the operations, the operation target device 2 provides the operation information to the department in charge of the next operation in the operation flow.

According to an embodiment of the present invention described above, the following effects are obtained.

(1) The operation management system 1 is a system that manages operations carried out by the persons 4A, 4B, and 4C in charge of operation in relation to the common operation target device 2. The operation management system 1 includes: the operation information DB 121 storing the operation information related to the implementation of the operations; the start notification unit 112 that notifies each person in charge of operation of the start of each of the operations when the start notification unit 112 detects the occurrence of the predetermined trigger event in the operation target device 2; the operation flow construction unit 113 that constructs the operation flow indicating the operation that needs to be carried out by each person in charge of operation in relation to the trigger event, on the basis of the operation information DB 121; the information providing unit 114 that provides the operation information with different content to each person in charge of operation on the basis of the operation flow; and the progress notification unit 115 that notifies the person in charge of operation of the progress of the operation. In this way, the operations carried out by the plurality of persons in charge of operation in relation to the common operation target can be appropriately managed.

(2) Each person in charge of operation is set to and belongs to any one of the department A, the department B, and the department C in an organization including the department A, the department B, and the department C. The information providing unit 114 provides the operation information to each person in charge of operation with content that varies according to the department the person in charge of operation belongs to (step S90). In this way, the operation information suitable for the department that each operator in charge of operation belongs to can be provided to the person in charge of operation.

(3) The operation information is stored in the operation information DB 121 in association with each department. In step S90, the information providing unit 114 can provide, to each person in charge of operation, the operation information of the department the person in charge of operation belongs to, in priority to the operation information of the other departments. In this way, the operation information with content optimal for each department the person in charge of operation belongs to can be surely provided to each person in charge of operation.

(4) The information providing unit 114 can also set the priorities for the plurality of pieces of operation information stored in the operation information DB 121 and provide the operation information to the persons in charge of operation on the basis of the set priorities. In this way, the operation information with content optimal for each department the person in charge of operation belongs to can also be surely provided to each person in charge of operation.

(5) The operation management system 1 includes: the past operation history DB 122 storing the past operation history related to the history of the operations carried out in the past; and the operation flow DB 123 storing the operation flows corresponding to the operations carried out in the past. The operation flow construction unit 113 extracts, from the operation flow DB 123, the past operation flow corresponding to the trigger event on the basis of the past operation history stored in the past operation history DB 122 (steps S40 and S50) and constructs the operation flow on the basis of the extracted past operation flow (step S60). In this way, the information of the operations carried out in the past can be used to easily construct the operation flow in relation to the trigger event of this time.

(6) The operation flow construction unit 113 may change part of the past operation flow extracted in step S50 on the basis of the trigger event to construct the operation flow in step S60. As a result, even if the operation flow corresponding to the trigger event of this time is not stored in the operation flow DB 123, the operation flow in relation to the trigger event of this time can be constructed.

Note that the embodiments and various modifications described above are just examples, and the present invention is not limited to the content as long as the features of the invention are not lost. In addition, although various embodiments and modifications are described above, the present invention is not limited to the content. Other conceivable modes within the technical concept of the present invention are also included in the scope of the preset invention.

### DESCRIPTION OF REFERENCE CHARACTERS

1: Operation management system
2: Operation target device
3A, 3B, 3C: Terminal apparatus
4A, 4B, 4C: Person in charge of operation
5: Network
11: Control unit
12: Database unit
13: Communication unit
111: Information collection unit
112: Start notification unit
113: Operation flow construction unit
114: Information providing unit
115: Progress notification unit
121: Operation information database
122: Past operation history database
123: Operation flow database

1. An operation management system that manages operations carried out by a plurality of persons in charge of operation in relation to a common operation target, the operation management system comprising:
an operation information database that stores operation information related to implementation of the operations;
a start notification unit that notifies each person in charge of operation of start of each of the operations when the start notification unit detects occurrence of a predetermined trigger event in the operation target;
an operation flow construction unit that constructs an operation flow indicating the operation to be carried out by each person in charge of operation in relation to the trigger event, on a basis of the operation information database;
an information providing unit that provides, to each person in charge of operation, the operation information with content suitable for the person in charge of operation on a basis of the operation flow; and
a progress notification unit that notifies each person in charge of operation of progress of the operation.

2. The operation management system according to claim 1, wherein
each person in charge of operation is set to and belongs to any one of a plurality of departments in an organization including the plurality of departments, and
the information providing unit provides, to each person in charge of operation, the operation information with content that varies according to the department the person in charge of operation belongs to.

3. The operation management system according to claim 2, wherein
the operation information is stored in the operation information database in association with each of the departments, and
the information providing unit provides, to each person in charge of operation, the operation information of the department the person in charge of operation belongs to in priority to the operation information of other departments.

4. The operation management system according to claim 1, wherein
the information providing unit sets priorities for a plurality of pieces of the operation information stored in the operation information database, and provides the operation information to each person in charge of operation on a basis of the set priorities.

5. The operation management system according to claim 1, comprising:
a past operation history database that stores a past operation history related to a history of the operation carried out in the past; and
an operation flow database that stores operation flows corresponding to the operations carried out in the past, wherein
the operation flow construction unit extracts, from the operation flow database, a past operation flow corresponding to the trigger event on a basis of the past operation history stored in the past operation history database and constructs the operation flow on a basis of the extracted past operation flow.

6. The operation management system according to claim 5, wherein
the operation flow construction unit changes part of the past operation flow on a basis of the trigger event to construct the operation flow.

7. An operation management method of, by using a computer, managing operations carried out by a plurality of persons in charge of operation in relation to a common operation target, the operation management method comprising:
connecting an operation information database that stores operation information related to implementation of the operations to the computer; and
by the computer,
notifying each person in charge of operation of start of each of the operations when detecting occurrence of a predetermined trigger event in the operation target;
constructing an operation flow indicating the operation to be carried out by each person in charge of operation in relation to the trigger event, on a basis of the operation information database that stores the operation information related to the implementation of the operations;
providing, to each person in charge of operation, the operation information with content suitable for the person in charge of operation on a basis of the operation flow; and
notifying each person in charge of operation of progress of the operation.

8. The operation management method according to claim 7, wherein
each person in charge of operation is set to and belongs to any one of a plurality of departments in an organization including the plurality of departments, and
the computer provides, to each person in charge of operation, the operation information with content that varies according to the department the person in charge of operation belongs to.

9. The operation management method according to claim 8, wherein
the operation information is stored in the operation information database in association with each of the departments, and
the computer provides, to each person in charge of operation, the operation information of the department the person in charge of operation belongs to in priority to the operation information of the other departments.

10. The operation management method according to claim 7, wherein
the computer sets priorities for a plurality of pieces of the operation information stored in the operation information database, and provides the operation information to each person in charge of operation on a basis of the set priorities.

11. The operation management method according to claim 7, wherein
a past operation history database that stores a past operation history related to a history of the operations carried out in the past and an operation flow database that stores operation flows corresponding to the operations carried out in the past are connected to the computer, and
the computer extracts, from the operation flow database, a past operation flow corresponding to the trigger event on a basis of the past operation history stored in the past operation history database and constructs the operation flow on a basis of the extracted past operation flow.

12. The operation management method according to claim 11, wherein
the computer changes part of the past operation flow on a basis of the trigger event to construct the operation flow.
